(19) United States
(12) Patent Application Publication
(10) Pub. No.: US 2026/0365371 A1
(43) Pub. Date: Nov. 19, 2026

(54) Recyclable Bottle Assembly

(71) Applicant: Andrea Wold, Burns Lake (CA)

(72) Inventor: Andrea Wold, Burns Lake (CA)

(21) Appl. No.: 19/293,000

(22) Filed: Aug. 7, 2025

Related U.S. Application Data
(60) Provisional application No. 63/805,356, filed on May 14, 2025.

(51) Int. Cl. B65D 23/08; B65C 3/08; B65C 9/46; B65D 1/02; G07F 17/00

(52) U.S. Cl. CPC B65D 23/085; B65C 3/08; B65C 9/46; B65D 1/0207; G07F 17/0014

(57) ABSTRACT

A recyclable bottle assembly that combines sustainable materials with customizable, decorative labeling is disclosed. The assembly includes a bottle body formed from recyclable materials such as rPET, PLA, or polymer-based plastics, and features an ergonomic contour for ease of use. An outer label or wrap made from recyclable or compostable materials, is affixed around the bottle body and displays custom artwork selected from a plurality of themes, including holidays, zodiac signs, sports, and seasonal motifs. The label or wrap can incorporate interactive elements such as a scannable digital interface for accessing hydration apps or digital art content and can include writable areas for personalization. In some embodiments, the label is color-responsive to temperature or sunlight. The bottle assembly is fully compatible with standard recycling systems.

### CROSS REFERENCE TO RELATED APPLICATION

The present application claims priority to, and the benefit of, U.S. Provisional Application No. 63/805,356 which was filed on May 14, 2025 and is incorporated herein by reference in its entirety.

### FIELD OF THE INVENTION

The present invention generally relates to recyclable beverage containers and consumer hydration products. More specifically, the present invention relates to a recyclable water bottle assembly configured to deliver both functional hydration and visual personalization through customizable artwork labels. The invention comprises a bottle body formed from environmentally sustainable materials such as rPET or PLA, designed with an ergonomic contour for user comfort. An outer label or wrap is affixed circumferentially around the bottle body and features high-resolution, theme-based artwork selected from a variety of decorative categories, including birthdays, sports, zodiac signs, and seasonal designs. Accordingly, the present disclosure makes specific reference thereto. Nonetheless, it is to be appreciated that aspects of the present invention are also equally applicable to other like applications, devices, and methods of manufacture.

### BACKGROUND

By way of background, conventional water bottles commonly feature minimalistic labels, often limited to a brand name or company logo. The standard labels offer little to no personalization, aesthetic engagement, or emotional connection for the consumer. Furthermore, most of the conventional water bottles are made from non-recyclable or single-use plastics, contributing to environmental waste and landfill accumulation.

As individuals are increasingly becoming sustainability-conscious, therefore, seek more eco-friendly alternatives that align with their personal values and lifestyles. At the same time, there is growing demand for products that offer a sense of individuality and enjoyment in everyday use. Accordingly, individuals desire a water bottle that is not only environmentally friendly but also offers unique, fun, and customizable label designs.

Therefore, there exists a long-felt need in the art for a recyclable water bottle that offers customized branding and provides customizable experience. There is a long-felt need for a water bottle that features a decorative label with user-relevant themes, such as birthdays, holidays, sports, or seasonal motifs. Additionally, there is a need for water bottles that encourage daily hydration through visually appealing and uplifting designs. Moreover, there exists a need in the art for beverage containers that combine eco-conscious manufacturing with personal expression. Finally, there is a long-felt need for water bottles that serve not only a practical hydration function but also as a collectible, giftable, or mood-boosting accessory for everyday use.

The subject matter disclosed and claimed herein, in one embodiment, comprises a recyclable water bottle assembly with a customized artwork label. The assembly includes a bottle body formed from recyclable materials, such as recycled polyethylene terephthalate (rPET), biodegradable polylactic acid (PLA), or other eco-friendly polymers. The bottle body features an ergonomic contour for comfortable handling and is designed to contain potable liquid. Affixed to the outer surface of the bottle body is a recyclable label made from materials like synthetic paper or compostable film. The label displays high-resolution custom artwork, printed using non-toxic, water-based inks, and can include design themes such as zodiac signs, seasonal graphics, sports logos, environmental messages, or celebratory motifs. The bottle includes a removable cap and is designed for full recyclability without requiring component separation.

In one embodiment, the outer label comprises a scannable digital interface, such as a QR code or NFC chip, that enables users to access associated digital content through a smartphone or imaging device. The label may further incorporate a user-writable area for gift personalization or inscriptions, enhancing its utility as a keepsake or personalized product.

In this manner, the recyclable water bottle assembly of the present invention addresses longstanding limitations in conventional water bottles. The water bottle assembly integrates sustainability, personalization, and interactivity into a single water bottle. The water bottle enables users to engage emotionally with a functional item, encourages frequent hydration, and promotes eco-conscious behavior through visible, thematic design. The water bottle utilizes recyclable materials to offer sustainability and reduce trash added to landfills.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises a recyclable water bottle assembly. The recyclable water bottle assembly comprises a bottle body formed from at least one recyclable material, the bottle body has a hollow cylindrical structure configured to contain potable liquid therein and an ergonomic contour to facilitate handheld grip during drinking. An outer label or wrap is disposed (i.e., affixed) circumferentially around at least a portion of an exterior surface of the bottle body, the outer label or wrap is formed from a recyclable material and includes custom artwork printed thereon. A bottle cap is removably coupled to a top opening of the bottle body. The bottle body and the outer label are compatible with municipal or industrial recycling systems and are recyclable without requiring separation of components prior to recycling.

In another embodiment, the bottle body formed from at least one recyclable material selected from the group consisting of recycled polyethylene terephthalate (rPET), biodegradable polylactic acid (PLA), and polymer-based recyclable plastic.

In one embodiment, a recyclable water bottle assembly is disclosed. The recyclable water bottle assembly comprises a bottle body formed from a recyclable material and configured to contain a potable liquid, an outer label or wrap is affixed to the exterior surface of the bottle body using a solvent-free adhesive or wrapped around the bottle body using a flexible wrap, the label comprises a front surface having custom artwork printed using water-based ink via digital or flexographic printing, a scannable digital interface element is disposed on the front surface, wherein the digital interface element is configured to be scanned by a digital imaging device to access digital content including hydration tracking applications, digital artwork galleries, and more. A user-writable area is disposed on the front surface of the label for gift personalization or message inscription, wherein the outer label or wrap is formed from a recyclable or compostable material and is configured to change color in response to ambient temperature or sunlight.

In yet another embodiment, the outer label or wrap is formed from a recyclable material selected from the group consisting of synthetic paper, compostable cellulose-based film, and biodegradable thermoplastics.

Numerous benefits and advantages of this invention will become apparent to those skilled in the art to which it pertains upon reading and understanding of the following detailed specification.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of recyclable water bottle assembly of the present invention in accordance with the disclosed structure;

FIG. 2 illustrates a perspective view of exemplary custom artwork label used in the recyclable water bottle assembly of the present invention in accordance with the disclosed structure;

FIG. 3 illustrates a perspective view showing a plurality of recyclable water bottle assemblies stored in a vending machine for accessibility in accordance with the disclosed structure; and

FIG. 4 illustrates another exemplary custom artwork label used in the recyclable water bottle assembly in accordance with the disclosed structure.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long-felt need in the art for a recyclable water bottle that offers customized branding and provides customizable experience. There is a long-felt need for a water bottle that features a decorative label with user-relevant themes, such as birthdays, holidays, sports, or seasonal motifs. Additionally, there is a need for water bottles that encourage daily hydration through visually appealing and uplifting designs. Moreover, there exists a need in the art for beverage containers that combine eco-conscious manufacturing with personal expression. Finally, there is a long-felt need for water bottles that serve not only a practical hydration function but also as a collectible, giftable, or mood-boosting accessory for everyday use.

The present invention, in one exemplary embodiment, is a recyclable water bottle assembly. The recyclable water bottle assembly comprises a bottle body formed from a recyclable material and configured to contain a potable liquid, an outer label or wrap is affixed to the exterior surface of the bottle body using a solvent-free adhesive or wrapped around the bottle body using a flexible wrap, the label comprises a front surface having custom artwork printed using water-based ink via digital or flexographic printing, a scannable digital interface element is disposed on the front surface, wherein the digital interface element is configured to be scanned by a digital imaging device to access digital content including hydration tracking applications, digital artwork galleries, and more. In one exemplary embodiment, the wrap is a neoprene insulating wrap. A user-writable area is disposed on the front surface of the label for gift personalization or message inscription, wherein the outer label or wrap is formed from a recyclable or compostable material and is configured to change color in response to ambient temperature or sunlight.

Reference will now be made in detail to the present preferred embodiments of the invention, examples of which are illustrated in the accompanying drawings. Wherever possible, the same reference numerals are used in the drawings and the description to refer to the same or like parts.

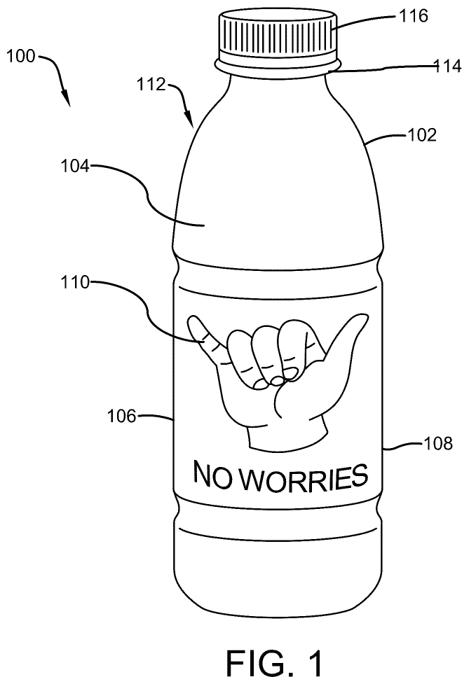

Referring initially to the drawings, FIG. 1 illustrates a perspective view of recyclable water bottle assembly of the present invention in accordance with the disclosed structure. The recyclable water bottle assembly 100 of the present invention is designed as an environmentally friendly water or beverage bottle to encourage sustainability. More specifically, the recyclable water bottle assembly 100 includes a bottle body 102 formed from a recyclable material. The bottle body 102 has a hollow cylindrical structure configured to contain potable liquid therein. Preferably, the bottle body 102 is made from one or a combination of recycled polyethylene terephthalate (rPET), biodegradable polylactic acid (PLA), or any polymer-based recyclable plastic. The bottle body 102 has an ergonomic contour 104 to facilitate handheld grip during drinking therefrom.

An outer label or wrap 106 is disposed (i.e., affixed) circumferentially around at least a portion of an exterior surface 108 of the bottle body 102. The outer label or wrap 106 has custom artwork or logo 110 disposed thereon for customizing the bottle assembly 100. In different embodiments, the custom artwork 110 can be selected from a plurality of unique designs including but not limited to birthday celebration designs, anniversary celebration designs, public holiday motifs, zodiac sign representations, environmental Earth-centric themes, sports team or sports event graphics, and seasonal or abstract decorative patterns. The outer label or wrap 106 is preferably formed of a recyclable material such as synthetic paper, compostable cellulose-based film, biodegradable thermoplastics, or insulating and flexible neoprene.

At the top end 112 of the bottle body 102, a top opening 114 of the bottle body 102 is positioned and a bottle cap 116 is removably coupled to the top opening 114 for preventing contamination of the stored water or beverage and providing access thereto.

It should be noted that the bottle body 102 and the outer label or wrap 106 are easily recyclable and are compatible with common municipal or industrial recycling systems without requiring separation of components prior to recycling. In some embodiments, the custom artwork label or wrap 106 is configured to be removable by a user prior to recycling and can be collected for personal use (i.e., reused with another bottle).

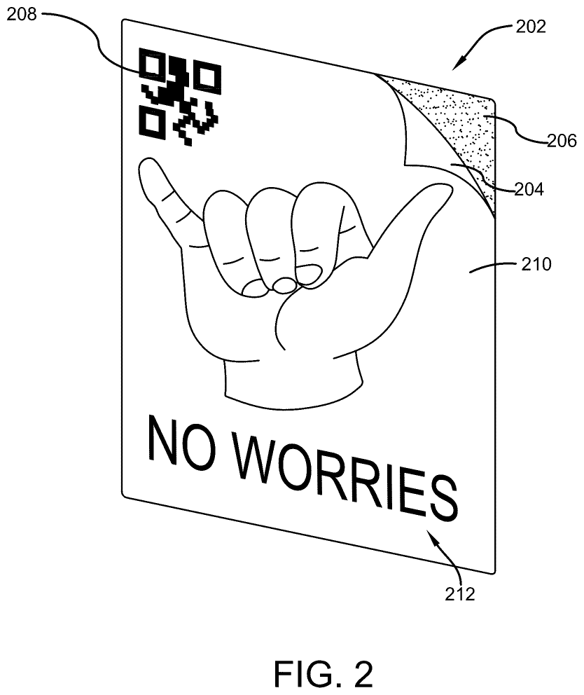

FIG. 2 illustrates a perspective view of exemplary custom artwork label or wrap 202 used in the recyclable water bottle assembly of the present invention in accordance with the disclosed structure. The custom artwork label 202 can be made using digital or flexographic printing for high resolution and can include water-based inks. In one embodiment, the rear surface 204 of the label 202 includes a solvent-free adhesive 206 for affixing to a bottle body. In another embodiment, the label 202 is a flexible wrap securable around the bottle body.

In one exemplary embodiment, a scannable digital interface element 208 is disposed on the front surface 210 of the label or wrap 202. The scannable digital interface element 208 can be scanned using a digital imaging device such as a smartphone camera to access one or more digital web pages or applications such as hydration tracking apps, or digital art galleries. At least one user-writable area 212 is disposed on the front surface 210 enabling gift personalization or message inscriptions.

The custom artwork label 202 can be temperature sensitive and can change colors based on the ambient temperature or sunlight directed at the label 202. Further, the custom artwork label 202 can be viewed via a digital imaging device such as smartphone camera.

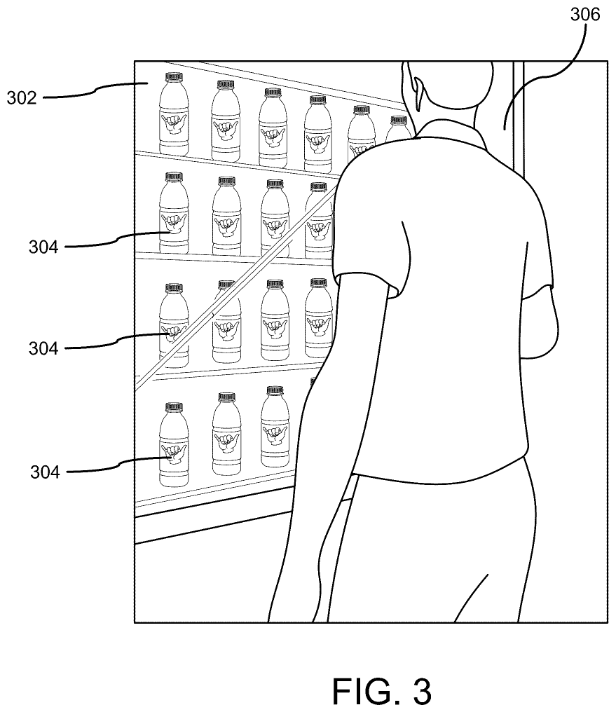

FIG. 3 illustrates a perspective view showing a plurality of recyclable water bottles 102 stored in a vending machine for accessibility in accordance with the disclosed structure. As illustrated, recyclable water bottles 102 can be stored in the vending machine 302. The vending machine includes a scannable digital interface element 303 that can scan an image from a smartphone using a digital imaging device. The vending machine includes a printer (not illustrated) that prints a recreation of the scanned image onto a custom label or wrap 304. Any water bottle 102 can be dispensed using the digital interface 306 of the vending machine 302. The chosen water bottle 102 then receives the printed custom label or wrap 304 recreated from the scanned image and can apply it to the water bottle 102 prior to dispensing from the vending machine 302. Alternatively, the vending machine 302 can dispense the water bottle 102 and the printed custom label or wrap 304 separately. The user can then apply the custom label or wrap 304 to the water bottle 102 after both have been dispensed to create the water bottle assembly 100. The user of the vending machine can thus customize the water bottle(s) it receives from the vending machine, whereby each bottle assembly includes a unique decorative and custom label or wrap 304. It is to be appreciated that although water is the described beverage in the recyclable bottle, any other beverage can be bottled in place of water.

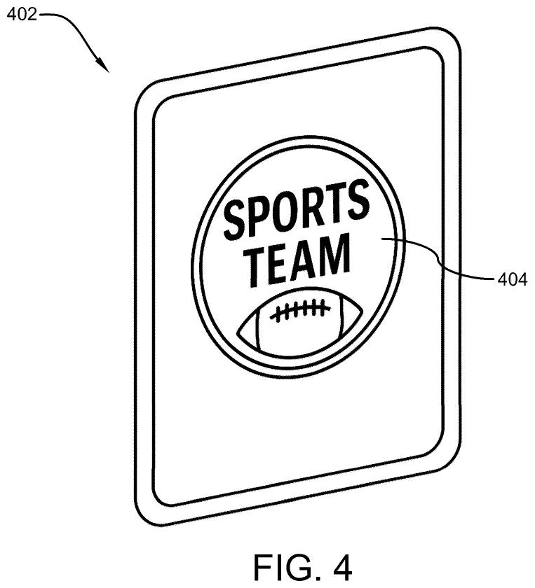

FIG. 4 illustrates another exemplary custom artwork label or wrap used in the recyclable water bottle assembly in accordance with the disclosed structure. In one exemplary embodiment, the label or wrap 402 includes a sports team logo 404 to meet preferences of sports enthusiasts. The logo 404 may glow in dark enabling a user to locate the bottle easily while providing aesthetics to the bottle assembly.

It should be noted that the bottle body can be made in different sizes such as 500 ml, 750 ml and more. Further, the bottle body can be tinted or transparent and is eco-friendly. The water bottle assembly of the present invention enables users to choose a bottle and also customize a label that fits their mood, personality, or the occasion. The recyclable materials reduce the number of single-use plastic bottles ending up in landfills and help users to be mindful of recycling through visible sustainable design.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “recyclable water bottle assembly, “eco-friendly beverage container”, “water bottle assembly”, and “bottle assembly” are interchangeable and refer to the eco-friendly water bottle assembly 100 of the present invention.

Notwithstanding the foregoing, the eco-friendly water bottle assembly 100 of the present invention can be of any suitable configuration as is known in the art without affecting the overall concept of the invention, provided that it accomplishes the above stated objectives. One of ordinary skill in the art will appreciate that the eco-friendly water bottle assembly 100 as shown in the FIGS. are for illustrative purposes only, and that many other configurations of the eco-friendly water bottle assembly 100 are well within the scope of the present disclosure. Although the dimensions of the eco-friendly water bottle assembly 100 are important design parameters for user convenience, the eco-friendly water bottle assembly 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A recyclable bottle assembly comprising:
a recyclable bottle assembly having a bottle body and an outer label;
wherein said bottle body having recyclable material and a cylindrical structure;
wherein said recyclable material selected from the group consisting of one or more of a recycled polyethylene terephthalate (rPET), a biodegradable polylactic acid (PLA), and a polymer-based recyclable plastic;
wherein said outer label is affixed circumferentially around at least a portion of an exterior surface of said bottle body;
wherein said outer label having customizable artwork disposed thereon for customizing said recyclable bottle assembly;
wherein said customizable artwork selected from the group consisting of a birthday celebration designs, an anniversary celebration designs, a public holiday motif, a zodiac sign representation, an environmental Earth-centric theme, a sports team, a sports event, a seasonal pattern, and a user created design; and
further wherein said outer label having a recyclable material selected from the group consisting of a synthetic paper, a compostable cellulose-based film, and a biodegradable thermoplastic.

2. The recyclable bottle assembly of claim 1, wherein said outer label is adhesively affixed around at least a portion of a circumference of said bottle body.

3. The recyclable bottle assembly of claim 1, wherein said outer label is an outer wrap having a material of insulating flexible neoprene.

4. The recyclable bottle assembly of claim 3, wherein said outer wrap securable around a circumference of said bottle body.

5. The recyclable bottle assembly of claim 4, wherein said outer wrap is selectively removable from said bottle body.

6. The recyclable bottle assembly of claim 5, wherein said outer wrap is reusable and securable around a circumference of another said bottle body.

7. The recyclable bottle assembly of claim 2, wherein said customizable artwork printed with flexographic printing.

8. The recyclable bottle assembly of claim 7, wherein said customizable artwork having a scannable digital interface element disposed on a surface of said outer label.

9. The recyclable bottle assembly of claim 8, wherein said scannable digital interface element scannable by a digital imaging device to access a digital web page.

10. The recyclable bottle assembly of claim 2, wherein said outer label having a user-writable area disposed on an outer surface of said outer label.

11. The recyclable bottle assembly of claim 2, wherein said outer label is temperature sensitive and changes color based on an ambient temperature.

12. The recyclable bottle assembly of claim 6, wherein said outer wrap is temperature sensitive and changes color based on an ambient temperature.

13. A recyclable bottle assembly comprising;
a recyclable bottle assembly having a bottle body and an outer label;
wherein said bottle body having recyclable material and a cylindrical structure;
wherein said recyclable material selected from the group consisting of one or more of a recycled polyethylene terephthalate (rPET), a biodegradable polylactic acid (PLA), and a polymer-based recyclable plastic;
wherein said outer label is affixed circumferentially around at least a portion of an exterior surface of said bottle body;
wherein said outer label having customizable artwork disposed thereon for customizing said recyclable bottle assembly;
wherein said customizable artwork selected from the group consisting of a birthday celebration designs, an anniversary celebration designs, a public holiday motif, a zodiac sign representation, an environmental Earth-centric theme, a sports team, a sports event, a seasonal pattern, and a user created design;
wherein said outer label is an outer wrap;
wherein said outer wrap having a recyclable material selected from the group consisting of a synthetic paper, a compostable cellulose-based film, a biodegradable thermoplastic, and an insulating flexible neoprene;
wherein said outer wrap securable around a circumference of said bottle body; and
further wherein said outer wrap having a user-writable area disposed on an outer surface of said outer wrap.

14. The recyclable bottle assembly of claim 13, wherein said outer wrap is selectively removable from said bottle body.

15. The recyclable bottle assembly of claim 14, wherein said outer wrap is reusable and securable around a circumference of another said bottle body.

16. The recyclable bottle assembly of claim 15, wherein said customizable artwork printed with flexographic printing.

17. The recyclable bottle assembly of claim 16, wherein said customizable artwork having a scannable digital interface element disposed on a surface of said outer label.

18. A method of providing a recyclable bottle assembly, the method comprising the steps of:
providing a vending machine including a plurality of recyclable bottles, a scannable digital interface, a printer, and a plurality of outer labels;
scanning an image from a smartphone with said scannable digital interface;
printing said image onto at least one of said plurality of outer labels;
choosing at least one of said plurality of recyclable bottles; and
dispensing said at least one of said plurality of outer labels and said at least one of said plurality of recyclable bottles.

19. The method of providing a recyclable bottle assembly of claim 18, further comprising a step of applying said at least one of said plurality of outer labels to said at least one of said plurality of recyclable bottles prior to said dispensing.

20. The method of providing a recyclable bottle assembly of claim 18, further comprising a step of applying said at least one of said plurality of outer labels to said at least one of said plurality of recyclable bottles after said dispensing.
